(19) United States
(12) Patent Application Publication
(10) Pub. No.: US 2019/0281979 A1
(43) Pub. Date: Sep. 19, 2019

(54) STORAGE UNIT WITH ADJUSTABLY-SIZED COMPARTMENTS AND SMART LOCKER USING SAME

(71) Applicant: Goldtek Technology Co., Ltd., New Taipei City (TW)

(72) Inventors: LIH-SIN LEE, Taipei (TW); WEI-CHING KUO, Taichung (TW); SHIAN-WEN SHIU, New Taipei (TW)

(21) Appl. No.: 16/116,127

(22) Filed: Aug. 29, 2018

(30) Foreign Application Priority Data
Mar. 14, 2018 (TW) 107108600

(51) Int. Cl. A47B 57/58; A47F 10/02; G06Q 30/06

(52) U.S. Cl. CPC A47B 57/585; A47F 10/02; A47B 2230/07; A47B 2220/0091; G06Q 30/0601

(57) ABSTRACT

A smart locker storage unit with compartments of adjustable size includes a housing and at least one detachable shelf assembly. The detachable shelf assembly in the housing interior space includes at least one shelf support, a detachable shelf, and at least one shelf lock. The shelf support is secured to the housing. The detachable shelf divides the housing interior space into a plurality of adjustably-sized compartments. The shelf lock is mounted on the shelf support. When the shelf lock is in a locked position, the shelf lock secures the detachable shelf on the shelf support. When the shelf lock is in an unlocked position, the shelf lock allows disengagement of the detachable shelf.

### FIELD

The present disclosure relates to smart lockers, and more particularly to a storage unit with adjustably-sized compartments and a smart locker using the same.

### BACKGROUND

Smart lockers are designed for e-commerce such that customers can collect or deposit goods conveniently after buying or selling goods over the internet. The smart locker includes at least one storage unit and a control console. The storage unit includes a plurality of compartments each having a door. The compartments are configured to store the goods. A control console controls operation of the doors of the storage unit. However, the compartments are fixed in size and any goods that are larger than the compartments may not be stored.

Thus, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic front view of an embodiment of a smart locker.

FIG. 2 is a schematic perspective view of a storage unit of the smart locker of FIG. 1 showing doors in open position.

FIG. 3A is a schematic perspective view of a detachable shelf assembly of the storage unit of the smart locker of FIG. 1 showing a detachable shelf mounted on shelf supports.

FIG. 3B is a schematic perspective view of the detachable shelf assembly of the storage unit of the smart locker of FIG. 1 showing the detachable shelf removed from the shelf supports.

FIG. 4 is a schematic perspective view of a shelf lock of the detachable shelf assembly of the storage unit of the smart locker of FIG. 1.

FIGS. 5A-5D are schematic perspective views of steps of removal of the detachable shelf of the detachable shelf assembly of the storage unit of the smart locker of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

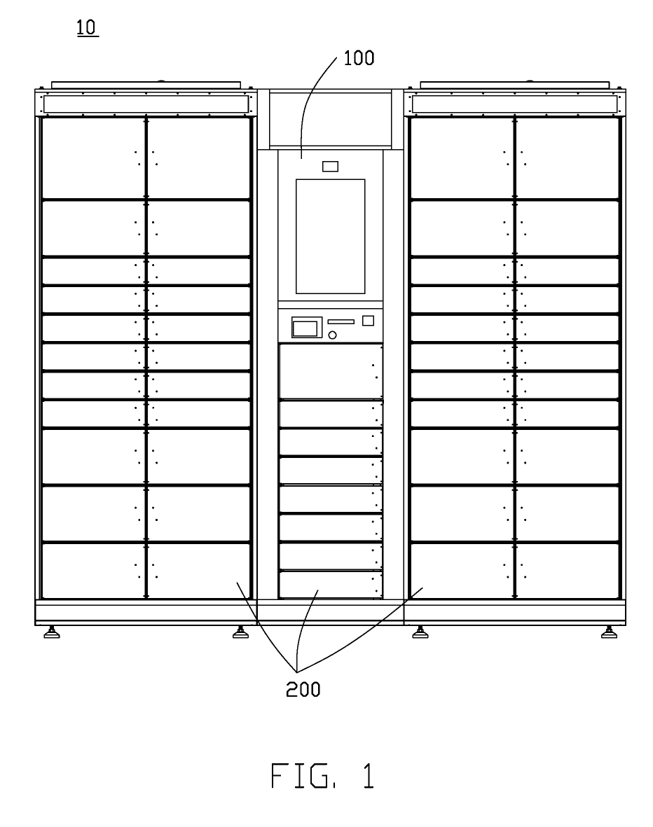

In FIG. 1, a smart locker 10 allows customers to collect or deposit goods conveniently after buying or selling goods over the internet. The smart locker 10 includes at least one storage unit 200 and a control console 100.

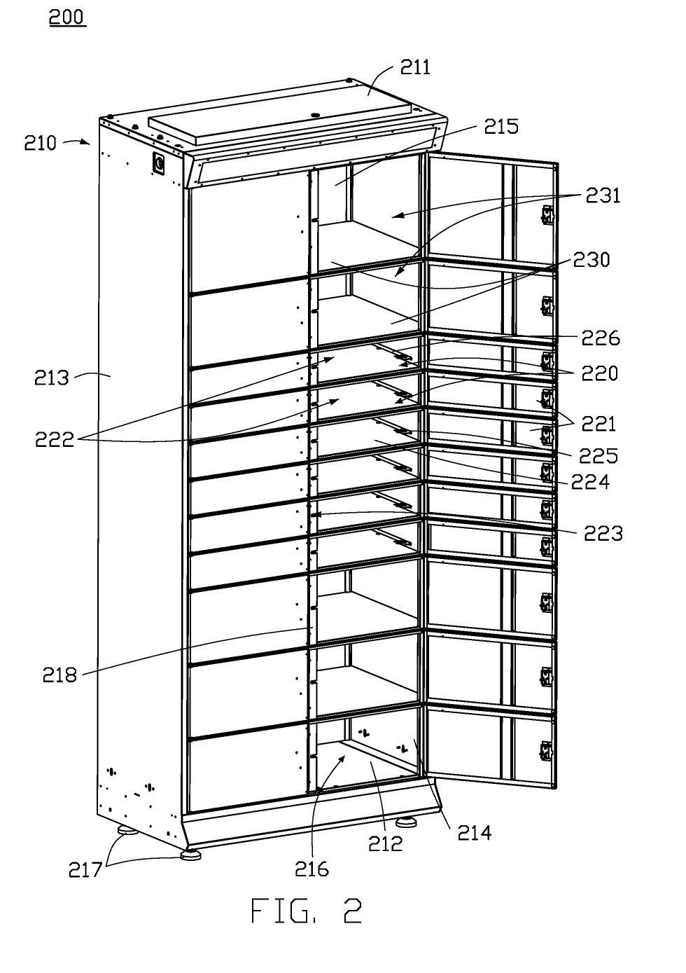

In FIG. 2, the storage unit 200 includes a housing 210 and at least one detachable shelf assembly 220. The housing 210 defines an interior space 216. The detachable shelf assembly 220 is located in the interior space 216. The detachable shelf assembly 220 includes at least one shelf support 226, a detachable shelf 224, and at least one shelf lock 225. The shelf support 226 is secured to the housing 210. The detachable shelf 224 is supported by the shelf support 226 to divide the interior space 216 of the housing 210 into a plurality of adjustably-sized compartments 222. The compartments 222 are configured to store the goods. Each compartment 222 has a door 221 that can open and close. The shelf lock 225 is mounted on the shelf support 226. When the shelf lock 225 is in a locked position, the shelf lock 225 engages the detachable shelf 224 to retain the detachable shelf 224 to the shelf support 226. When the shelf lock 225 is in an unlocked position, the shelf lock 225 releases the detachable shelf 224 to allow the detachable shelf 224 to be removed from the shelf support 226. Therefore, one or more detachable shelves 224 may be removed from two or more smaller compartments 222 to form a larger compartment to store larger-sized goods.

The control console 100 controls the operation of the doors 221 of the storage unit 200 for allowing the customers to take out (collect) goods from the compartments 222 or to place (deposit) goods into the compartments 222. The control console 100 may include components such as touch screen, scanning device, processor, and wireless communication device. The control console 100 is conventional and thus will not be described in detail.

In an embodiment, the housing 210 is substantially cubic and has a top wall 211, a bottom wall 212, a rear wall 215, and a pair of side walls 213, 214 defining the interior space 216. The storage unit 200 further includes a central partition 218, at least one fixed shelf 230, and a plurality of adjustable feet 217. The central partition 218 is located in the interior space 216 of the housing 210 to divide the interior space 216 into two parts. Typically, the two parts may be equal in size, but they need not be. The fixed shelf 230 is located in the interior space 216 to divide the interior space 216 into a plurality of separate compartments 231. The adjustable feet 217 are mounted on the housing 210. The adjustable feet 217 are independently adjustable to allow levelling of the housing 210. Each door 221 can be locked by a door lock 223. The control console 100 controls the operation of the door locks 223 to lock or unlock the doors 221.

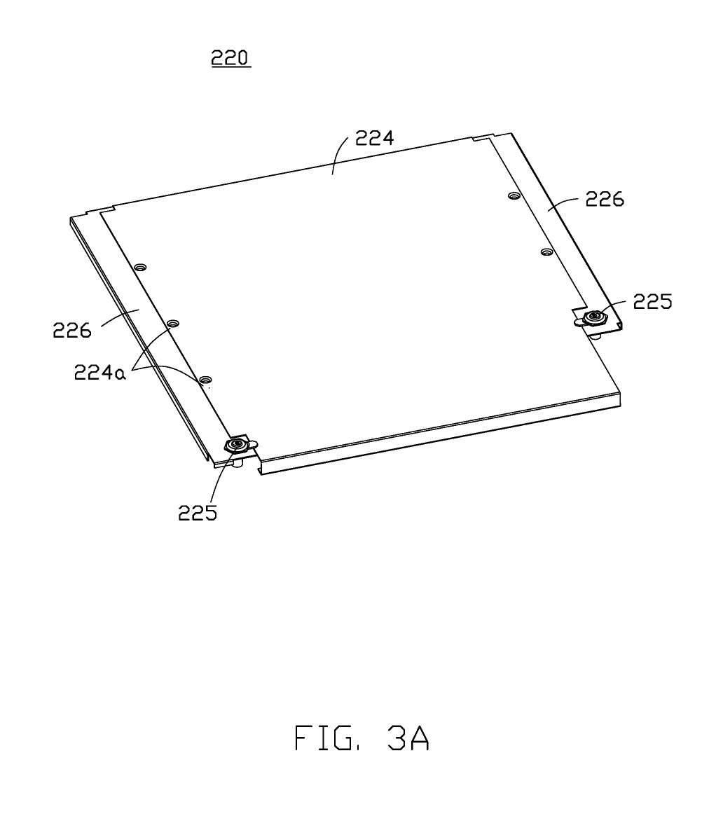

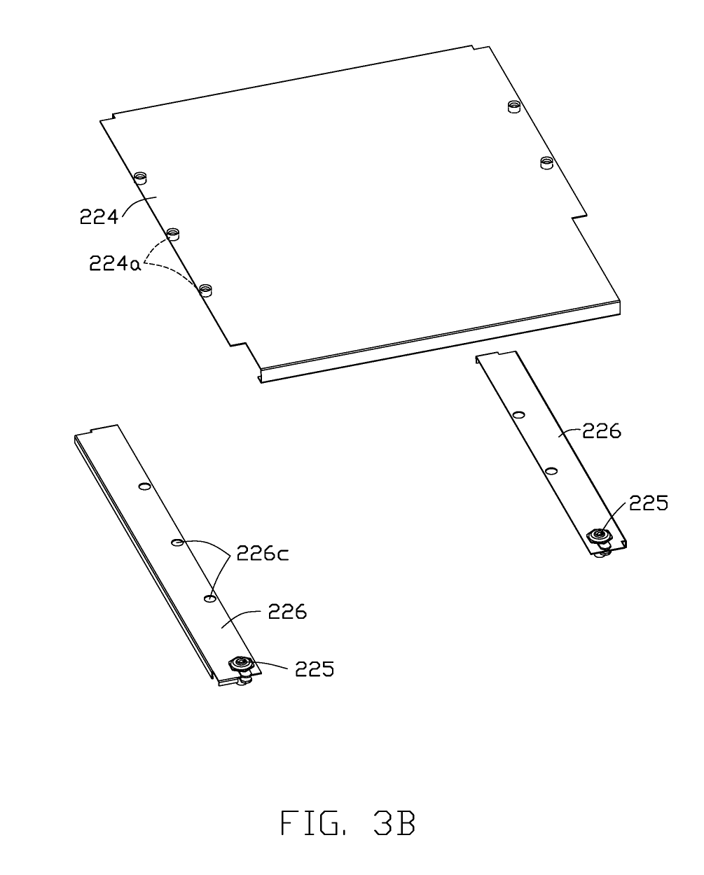

In the present embodiment, the detachable shelf assembly 220 includes two shelf supports 226 and two shelf locks 225. One shelf support 226 is secured to one of the side walls 213, 214 of the housing 210, and the other shelf support 226 is secured to the central partition 218. FIGS. 3A and 3B show that each shelf support 226 has at least one engaging hole 226c. The detachable shelf 224 has two sides each having at least one downward engaging projection 224a. The engaging projections 224a of the detachable shelf 224 can be inserted into the engaging holes 226c of the two shelf supports 226. One shelf lock 225 is mounted on each of the two shelf supports 226.

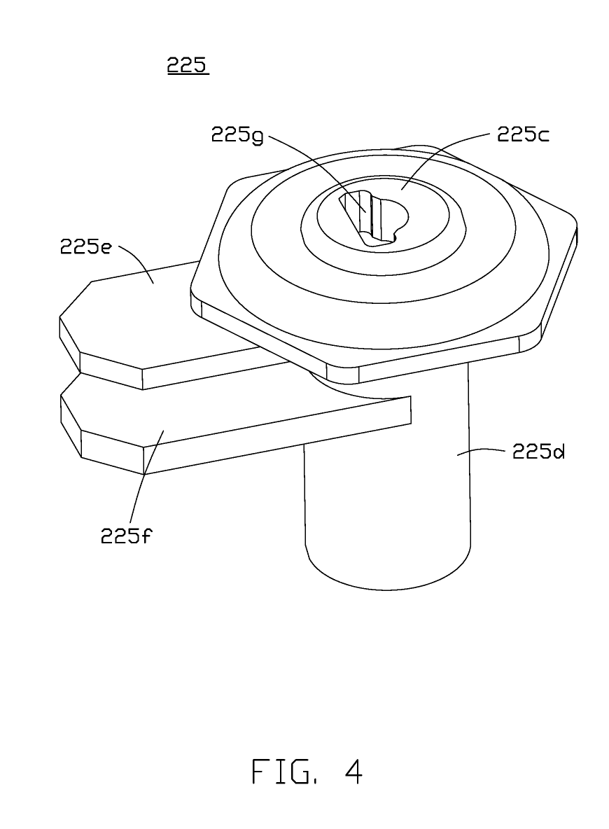

In FIG. 4, each shelf lock 225 includes a body 225d, a head 225c, an upper locking member 225e, a lower locking member 225f, and a locking hole 225g. The body 225d is mounted on the shelf support 226. The head 225c is attached to a top of the body 225d. The upper locking member 225e and the lower locking member 225f are spaced apart and attached to a peripheral surface of the body 225d. The locking hole 225g is formed in the head 225c. A key (not shown) rotates the upper locking member 225e and the lower locking member 225f to a first position or a second position such that the shelf lock 225 is in the locked or unlocked positions. In FIG. 3A, when the shelf locks 225 are in the locked position, the upper locking member 225e and the lower locking member 225f are rotated to the first position to engage the detachable shelf 224, preventing the detachable shelf 224 from moving upwardly. In FIG. 3B, when the shelf locks 225 are in the unlocked position, the upper locking member 225e and the lower locking member 225f are rotated to the second position to disengage the detachable shelf 224, allowing the detachable shelf 224 to move upwardly.

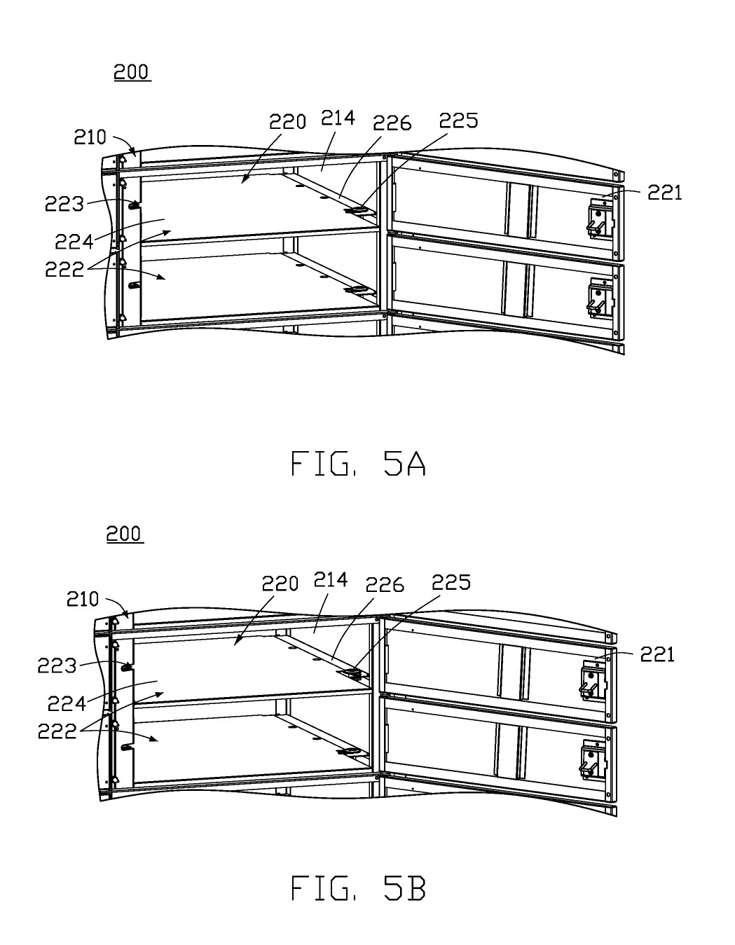

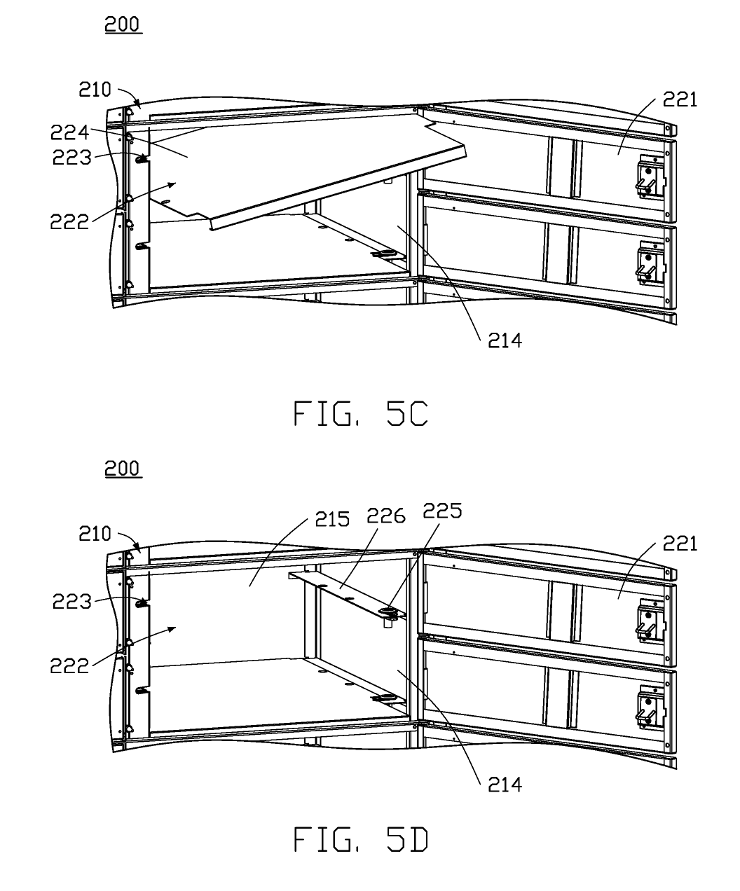

FIGS. 5A-5D show removal steps of the detachable shelf 224.

In FIG. 5A, the shelf locks 225 are in the locked position, so that the detachable shelf 224 is held on the shelf supports 226.

In FIG. 5B, the shelf locks 225 are rotated to the unlocked position, allowing the detachable shelf 224 to move upwardly.

In FIG. 5C, the detachable shelf 224 is moved upwardly and then inclined, so that the detachable shelf 224 is taken out of the housing 210.

In FIG. 5D, the two smaller compartments 222 form one larger compartment 222 to store larger-sized goods.

The embodiments shown and described above are only examples. Many details are often found in this field of art thus many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A storage unit comprising:
a housing defining an interior space; and
at least one detachable shelf assembly located in the housing interior space, and the detachable shelf assembly comprising:
at least one shelf support secured to the housing;
a detachable shelf supported by the shelf support to divide the housing interior space into a plurality of adjustably-sized compartments, and each compartment having a door; and
at least one shelf lock mounted on the shelf support;
wherein when the shelf lock is in a locked position, the shelf lock engages the detachable shelf to prevent the shelf from being detached, and when the shelf lock is in an unlocked position, the shelf lock disengages the detachable shelf to allow the shelf to be detached.

2. The storage unit of claim 1, further comprising a central partition located in the housing interior space;
wherein the housing has a top wall, a bottom wall, a rear wall, and a pair of side walls defining the housing interior space.

3. The storage unit of claim 2, wherein the detachable shelf assembly comprises two shelf supports, one shelf support is secured to one of the side walls of the housing, and the other shelf support is secured to the central partition.

4. The storage unit of claim 3, wherein the detachable shelf assembly comprises two shelf locks mounted respectively on the two shelf supports.

5. The storage unit of claim 1,
wherein the shelf support defines at least one engaging hole; and
wherein the detachable shelf has at least one engaging projection for insertion into the shelf support engaging hole.

6. The storage unit of claim 1,
wherein the shelf lock comprises:
a body mounted on the shelf support; and
an upper locking member and a lower locking member attached to the body; and
wherein when the shelf lock is in the locked position, the upper locking member and the lower locking member engage the detachable shelf to prevent the shelf from being detached, and when the shelf lock is in the unlocked position, the upper locking member and the lower locking member disengage the detachable shelf to allow the shelf to be detached.

7. The storage unit of claim 6, wherein the shelf lock comprises:
a head attached to the body; and
a locking hole defined in the head.

8. The storage unit of claim 1, wherein each door can be locked closed by a door lock.

9. The storage unit of claim 1, further comprising at least one fixed shelf located in the housing interior space to divide the interior space into a plurality of separate compartments.

10. The storage unit of claim 1, further comprising a plurality of adjustable feet mounted on the housing.

11. A smart locker comprising:
at least one storage unit comprising:
a housing defining an interior space; and
at least one detachable shelf assembly located in the housing interior space, and the detachable shelf assembly comprising:
at least one shelf support secured to the housing;
a detachable shelf supported by the shelf support to divide the housing interior space into a plurality of adjustably-sized compartments, and each compartment having a door; and
at least one shelf lock mounted on the shelf support; and
a control console controlling operation of the doors of the storage unit;
wherein when the shelf lock is in a locked position, the shelf lock engages the detachable shelf to prevent the shelf from being detached, and when the shelf lock is in an unlocked position, the shelf lock disengages the detachable shelf to allow the shelf to be detached.

12. The smart locker of claim 11,
wherein the storage unit comprises a central partition located in the housing interior space; and
wherein the housing has a top wall, a bottom wall, a rear wall, and a pair of side walls defining the interior space.

13. The smart locker of claim 12, wherein the detachable shelf assembly comprises two shelf supports, one shelf support is secured to one of the side walls of the housing, and the other shelf support is secured to the central partition.

14. The smart locker of claim 13, wherein the detachable shelf assembly comprises two shelf locks mounted respectively on the two shelf supports.

15. The smart locker of claim 11,
wherein the shelf support defines at least one engaging hole; and
wherein the detachable shelf has at least one engaging projection for insertion into the shelf support engaging hole.

16. The smart locker of claim 11,
wherein the shelf lock comprises:
a body mounted on the shelf support; and
an upper locking member and a lower locking member attached to the body; and
wherein when the shelf lock is in the locked position, the upper locking member and the lower locking member engage the detachable shelf to prevent the shelf from being detached, and when the shelf lock is in the unlocked position, the upper locking member and the lower locking member disengage the detachable shelf to allow the shelf to be detached.

17. The smart locker of claim 16, wherein the shelf lock comprises:
a head attached to the body; and
a locking hole defined in the head.

18. The smart locker of claim 11,
wherein each door can be locked closed by a door lock; and
wherein the control console controls operation of the door locks to lock or unlock.

19. The smart locker of claim 11, wherein the storage unit comprises at least one fixed shelf located in the housing interior space to divide the interior space into a plurality of separate compartments.

20. The smart locker of claim 11, wherein the storage unit comprises a plurality of adjustable feet mounted on the housing.
